(19) United States
(12) Patent Application Publication
(10) Pub. No.: US 2017/0313400 A1
(43) Pub. Date: Nov. 2, 2017

(54) COLLAPSIBLE UNMANNED AERIAL VEHICLE (UAV)

(71) Applicant: ATLAS DYNAMIC LIMITED, Dublin (IE)

(72) Inventor: Igor Zhydanov, Riga (LV)

(21) Appl. No.: 15/497,704

(22) Filed: Apr. 26, 2017

Related U.S. Application Data
(60) Provisional application No. 62/328,534, filed on Apr. 27, 2016.

(51) Int. Cl. B64C 1/06; B64C 39/02

(52) U.S. Cl. CPC B64C 1/063; B64C 39/024; B64C 2201/20; B64C 2201/108

(57) ABSTRACT

Disclosed is an aerial vehicle such as an unmanned aerial vehicle (UAV). In one implementation, the vehicle includes a base and one or more front-facing arms extending from the base. Each front facing arm includes an inner segment affixed to the base and an outer segment. The vehicle also includes a rear-facing arm affixed to the base. In another implementation, a UAV includes one or more arms mounted to a base. At least one of the arms includes a first segment that is proximate to the base and a second segment that is distant from the base. A first hinge connects the first segment and the second segment. Various dimensions of the UAV are reduced when the arm(s) are folded along the first hinge.

### CROSS-REFERENCE TO RELATED APPLICATIONS

This application is related to and claims the benefit of U.S. Patent Application No. 62/328,534, filed Apr. 27, 2016 which is incorporated herein by reference in its entirety.

### TECHNICAL FIELD

Aspects and implementations of the present disclosure relate to vehicles and more specifically to unmanned aerial vehicles (UAVs).

### BACKGROUND

Unmanned vehicles (e.g., unmanned aerial vehicles (UAVs)) can be used for a wide variety of tasks. Such vehicles can be constructed to include various components in various dimensions.

### SUMMARY

The following presents a shortened summary of various aspects of this disclosure in order to provide a basic understanding of such aspects. This summary is not an extensive overview of all contemplated aspects, and is intended to neither identify key or critical elements nor delineate the scope of such aspects. Its purpose is to present some concepts of this disclosure in a compact form as a prelude to the more detailed description that is presented later.

Disclosed is an aerial vehicle such as an unmanned aerial vehicle (UAV). In one implementation, the vehicle includes a base and one or more front-facing arms extending from the base. Each front facing arm includes an inner segment affixed to the base and an outer segment. The vehicle also includes a rear-facing arm affixed to the base.

In another implementation, a UAV includes one or more arms mounted to a base. At least one of the arms includes a first segment that is proximate to the base and a second segment that is distant from the base. A first hinge connects the first segment and the second segment. Various dimensions of the UAV are reduced when the arm(s) are folded along the first hinge.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIGS. 1A-1C illustrate various embodiments of a vehicle or device, according to an example embodiment.

FIGS. 2A-2B depict further aspects of a vehicle or device, according to an example embodiment.

FIG. 3 depicts further aspects of a vehicle or device, according to an example embodiment.

FIG. 4 depicts further aspects of a vehicle or device, according to an example embodiment.

FIG. 5 depicts further aspects of a vehicle or device, according to an example embodiment.

FIGS. 6A-6B depict further aspects of a vehicle or device, according to an example embodiment.

FIGS. 7A-7D depict further aspects of a vehicle or device, according to an example embodiment.

FIGS. 8A-8C depict further aspects of a vehicle or device, according to an example embodiment.

FIGS. 9A-9B depict further aspects of a vehicle or device, according to an example embodiment.

FIG. 10 depicts further aspects of a vehicle or device, according to an example embodiment.

### DETAILED DESCRIPTION

Aspects and implementations of the present disclosure are directed to aerial vehicles and more specifically to collapsible unmanned aerial vehicles (UAVs).

It can be appreciated that unmanned vehicles (e.g., unmanned aerial vehicles (UAVs)) or ‘drones’ may be constructed to have certain dimensions. However, while such dimensions may be dictated by operational aspects of the UAV, such dimensions may also result in inconveniences/inefficiencies in other contexts. For example, the size of many UAVs make it such that it is difficult to travel with (e.g., pack/carry, such as within hand luggage to be carried on to an airplane or to carry on one's back).

Accordingly, described herein in various implementations is a collapsible UAV (and/or any other such remote controlled device, vehicle, etc.). As described herein, various elements of the UAV (e.g., one or more of the arms or rays of the UAV) can be folded, collapsed, or otherwise adjusted in various ways. By folding, collapsing, etc., element(s) of the UAV, the UAV can occupy considerably less space (as opposed to when open/unfolded). In doing so, such a UAV can be transported easily in various contexts in a collapsed state (e.g., when traveling on an airplane, when a user is carrying it, etc.). The UAV can later be opened up (e.g., in order to enable a user to control/navigate the UAV), as described herein.

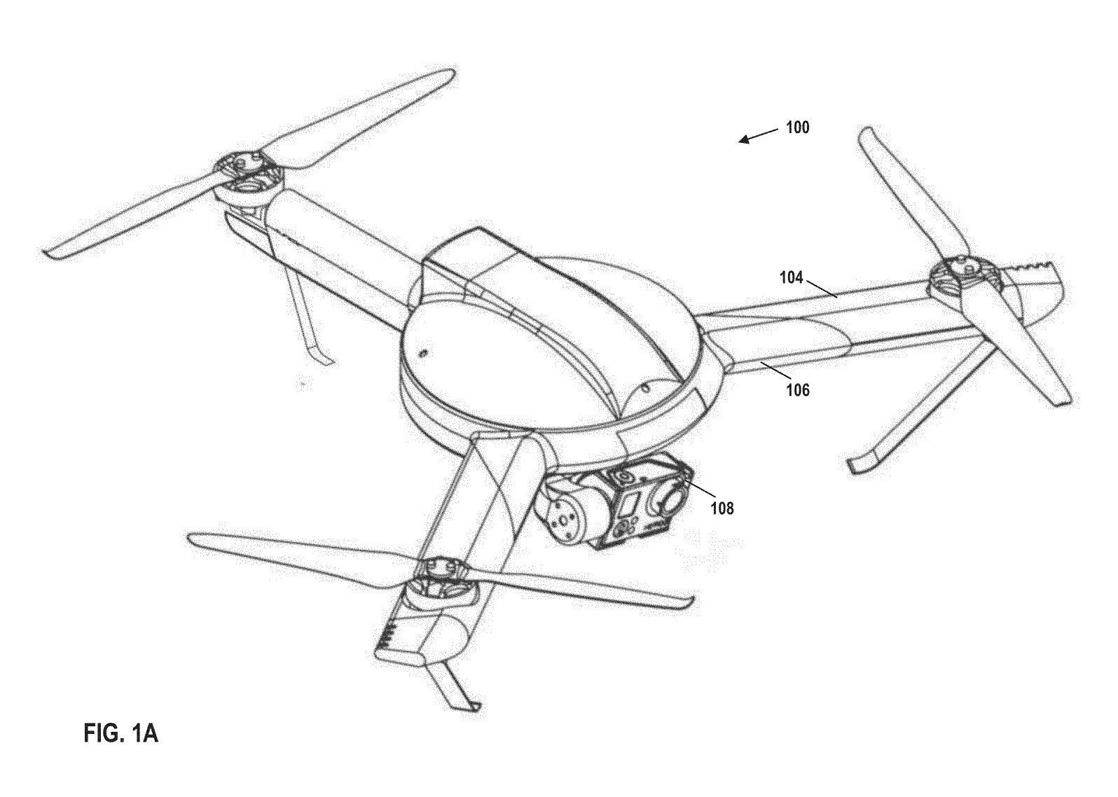

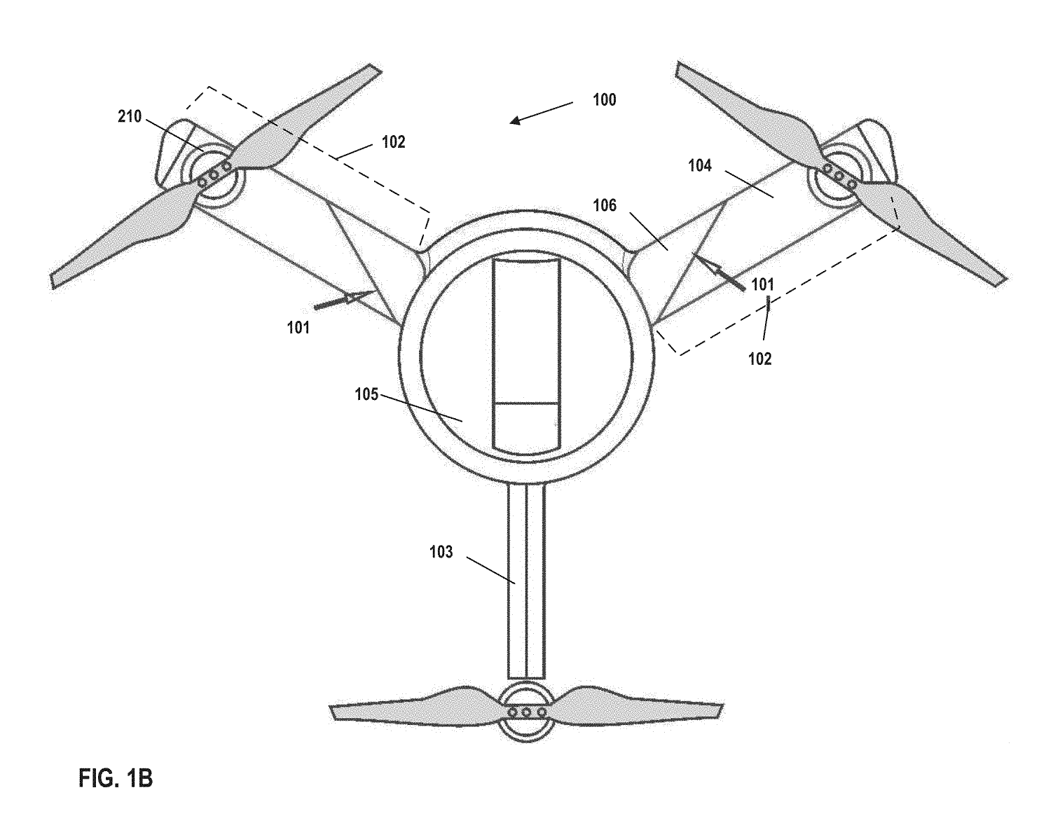

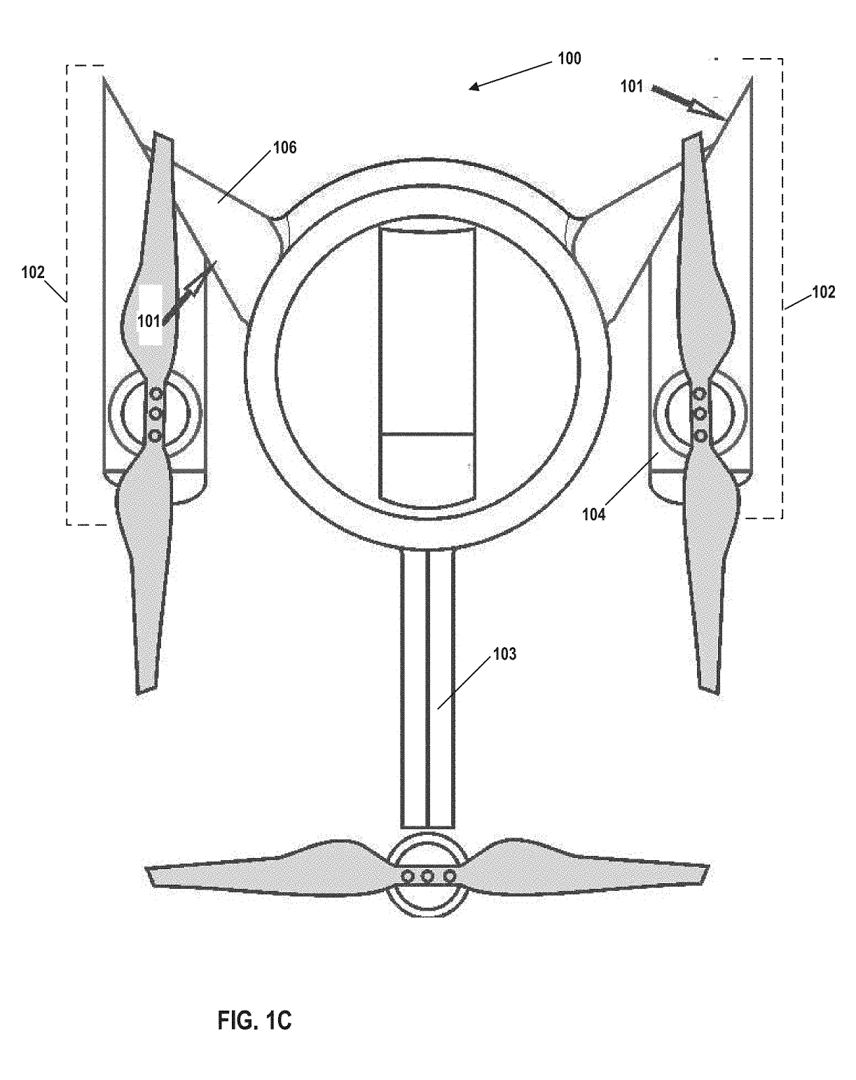

Described herein are various embodiments of a vehicle or device 100 (e.g., a UAV or ‘drone’), such as UAV 100 as depicted in FIGS. 1A-IC. In various embodiments, the UAVs described herein may include UAVs of various types, sizes, shapes, and configurations. For example, the UAVs may include multi-rotor aircrafts such as helicopters, tricopters, quadcopters, hexacopters, octocopters, and the like. Furthermore, the UAVs described herein may be used in a wide variety of applications including but not limited to remote sensing, aerial surveillance, oil, gas and mineral exploration and production, transportation, scientific research, aerial photography or videography, mapping, disaster reporting, search and rescue, mapping, power line patrol, weather reporting and/or prediction, traffic detection and reporting.

In various embodiments, a UAV may be autonomously-controlled by an onboard controller or processor, remotely-controlled by a remote device (e.g., a ground station or a hand-held remote control device), or jointly controlled by both. In some embodiments, the UAV may be configured to carry a payload device 108 such as a camera or a video camera via a carrier (e.g., as depicted in FIG. 1A). The payload device may be used to capture images of surrounding environment, collect samples, or perform other tasks.

As used herein, the terms “upper,” “lower,” “vertical,” “horizontal” and other similar position-indicating terms are used with reference to the UAV in its normal operational mode, and should not be considered limiting. Throughout the description, a tricopter (a helicopter with three rotors) is used as a UAV for illustrative purposes only. It is appreciated that the techniques described herein can be used for other types of UAVs such as a quadcopter, etc.

As shown in FIG. 1B, in certain implementations UAV 100 can include two forward or front facing arms or rays 102. Each of the referenced arms/rays 102 can be made up of multiple segments such as an inner/interior segment 106 (which connects to the body/central portion/base 105 of UAV 100) and an outer segment 104 which includes motor 210, as described herein. It should be understood that the inner segment 106 and outer segment 104 of ray 102 can be joined at point 101 (as shown), e.g., by one or more hinge(s), joints, etc., as described and depicted herein and/or in a manner known to those of ordinary skill in the art.

It should be understood that FIG. 1B depicts an overhead view of UAV 100 having rays 102 extended/opened while FIG. 1C depicts an overhead view of UAV 100 having rays 102 folded, e.g., along point 101, as shown. It can be appreciated that, as shown in FIG. 1C, that when rays/arms 102 are folded/collapsed, the outer segments 104 of rays 102 can be positioned/aligned to be parallel to rear ray/arm 103.

As noted above, by folding rays 102, the dimensions of UAV 100 can be reduced considerably, thereby enabling the UAV to be stored and/or transported in any number of additional contexts.

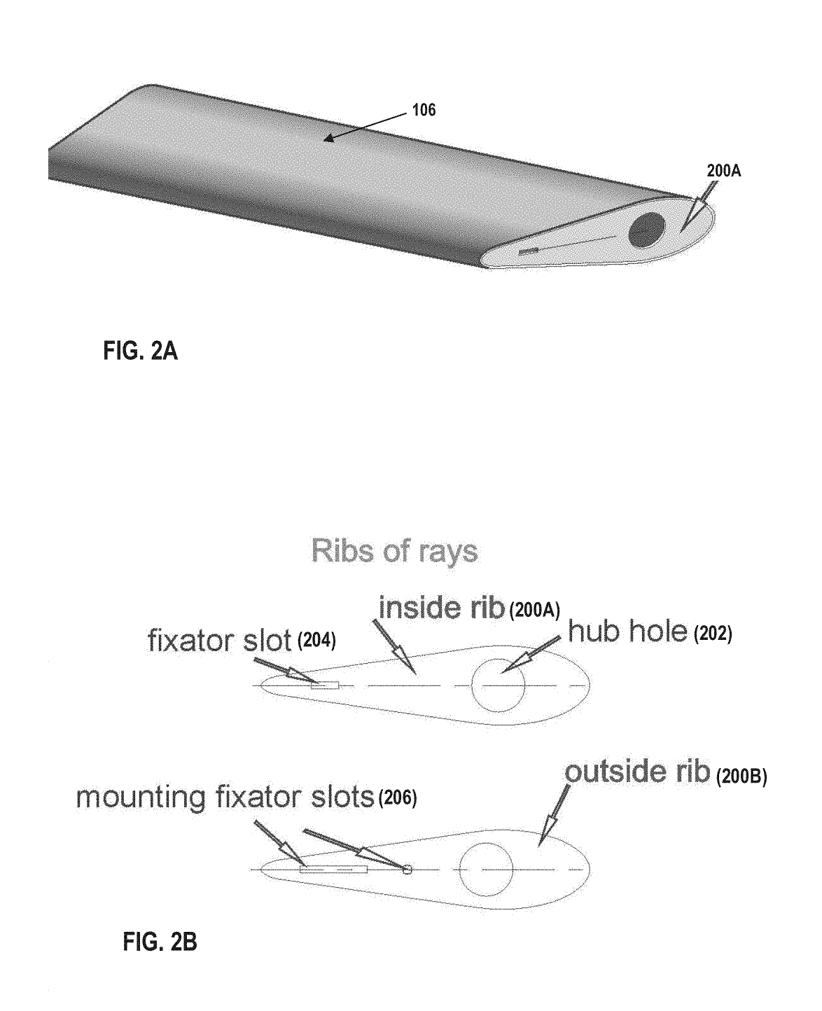

FIGS. 2A-2B depict further aspects of arm/ray 102. It should be understood that the ray can be affixed to the body of UAV 100, e.g., via glue and/or any other affixation method, technique, etc. FIG. 2A depicts the inside 200A of arm/ray 102 (here, segment 106). It should also be noted that ray 102 may include various slots, as shown and described herein. For example, as shown in FIG. 2B, inside rib 200A can include fixator slot 204 and hub hole 202 (with respect to which hub 304 can be positioned, as described herein). Additionally, as shown in FIG. 2B, outside rib 200B (corresponding to the internal portion of segment 104 or arm/ray 102) can include mounting fixator slots 206, as described herein.

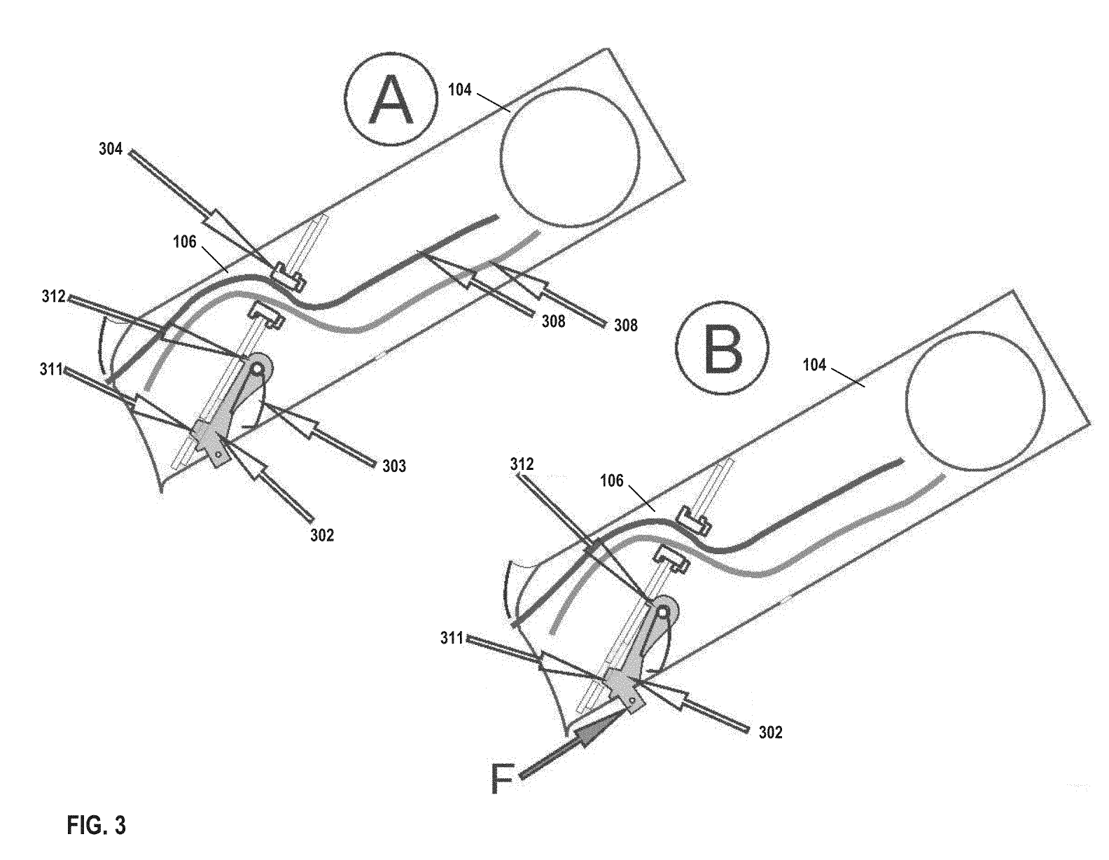

FIG. 3 depicts various aspects of ray 102, such as those that enable the ray to be folded. As shown in FIG. 3, ray 102 can be positioned in a locked position (as shown with respect to position ‘A’ of FIG. 3) or an unlocked position (as shown with respect to position ‘B’ of FIG. 3). As shown in FIG. 3, the respective segments 104 and 106 of ray 102 can be locked via lock 302 which, in certain implementations, may be positioned/incorporated within and/or otherwise mounted to segment 104. In certain implementations, the segments 104, 106 can be constructed/assembled such that a ‘tongue’ portion 311 of the lock 302 enters into a slot that is present within segment 106 (e.g., as shown in FIG. 2B). In such a position, the latch of the ray 102 is locked against rotation (e.g., along the hinge, etc., that connects the two segments).

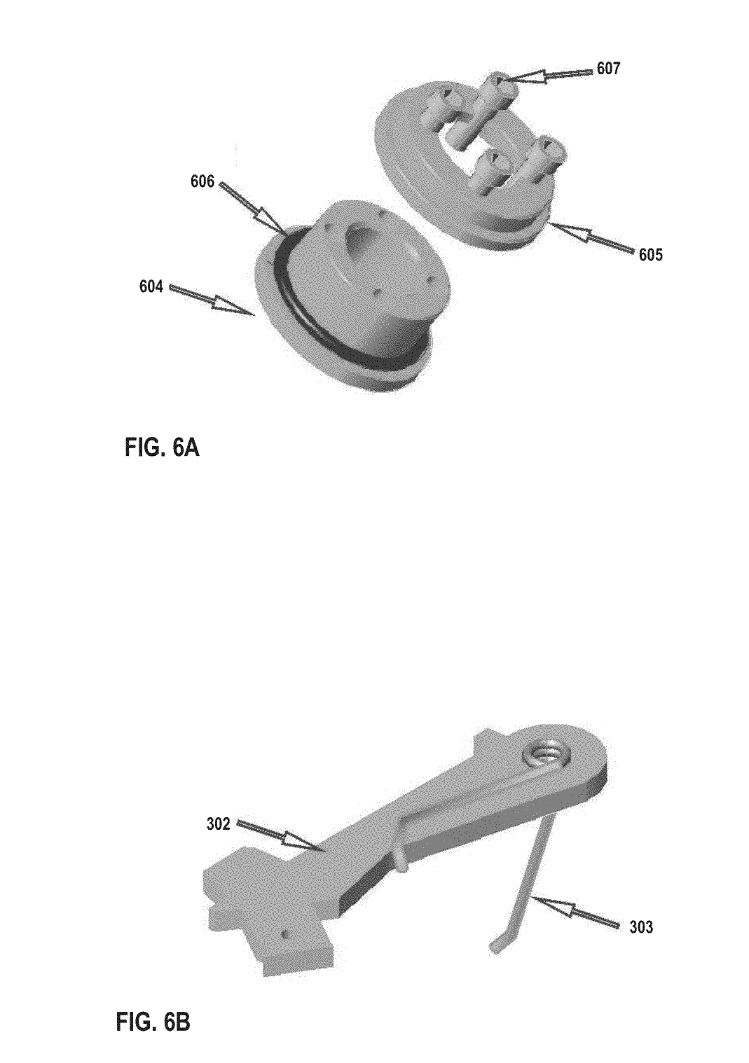

When lock 302 (which may also include torsion spring 303, as shown and described in detail herein) is moved or pushed in the direction of arrow ‘F’ (as shown in position ‘B’ of FIG. 3), the referenced lock 302 can become unlocked such that the lock 302 can rotate relative to point 312 and the ray can fold along the referenced hinge, thereby enabling segments 104 and 106 to separate from one another along the hinge. Further aspects of certain implementations of lock 302 and torsion spring 303 are also depicted in FIG. 6B.

As also shown in FIG. 3, wiring 308 can provide power and/or commands (e.g., from elements contained within body/base 105, e.g., a battery, processing/communication circuitry, etc.) to the motor. In certain implementations, wiring 308 can pass through hub 304, as shown.

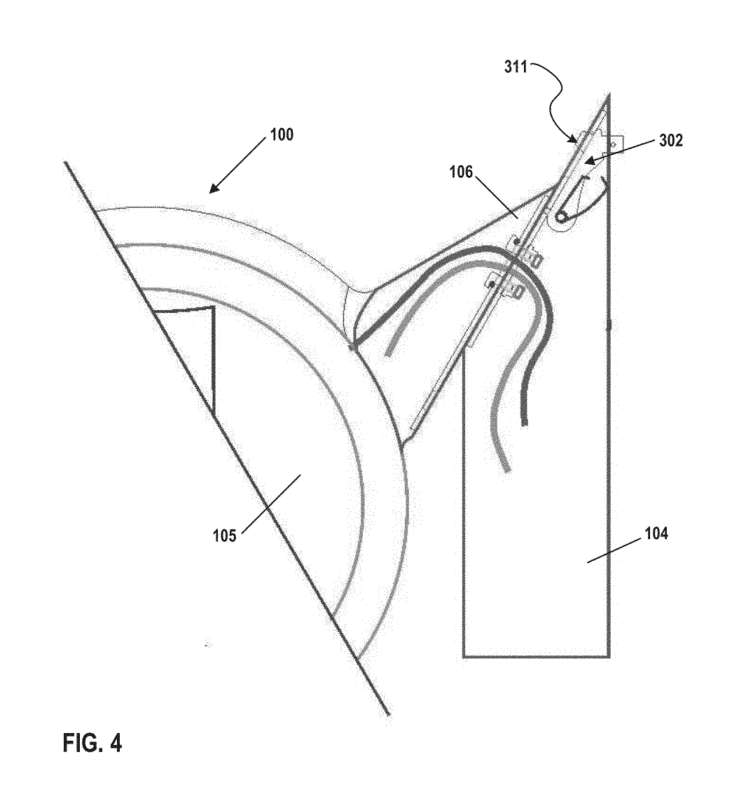

FIG. 4 depicts a further example of ray 102 in a fully folded state, showing segments 104 and 106 separated from one another along the referenced hinge.

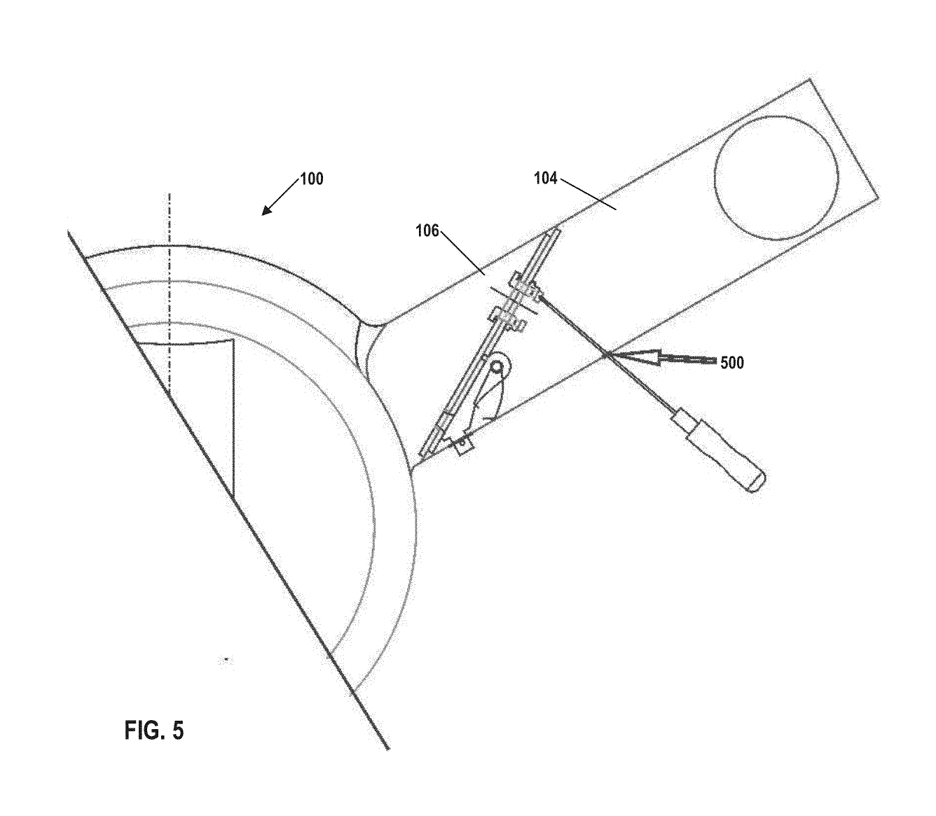

FIG. 5 depicts an example of the mounting of the hub 304 thorough an opening 500 in ray 102.

FIGS. 6A-6B depict further aspects and elements of ray 102. As shown in FIG. 6A, elements 604 and 605 correspond to parts of hub 304. Rubber ring 606 can surround element 604 and screws 607 can secure element 605 to element 604. FIG. 6B depicts aspects of certain implementations of lock 302 and torsion spring 303 as described above.

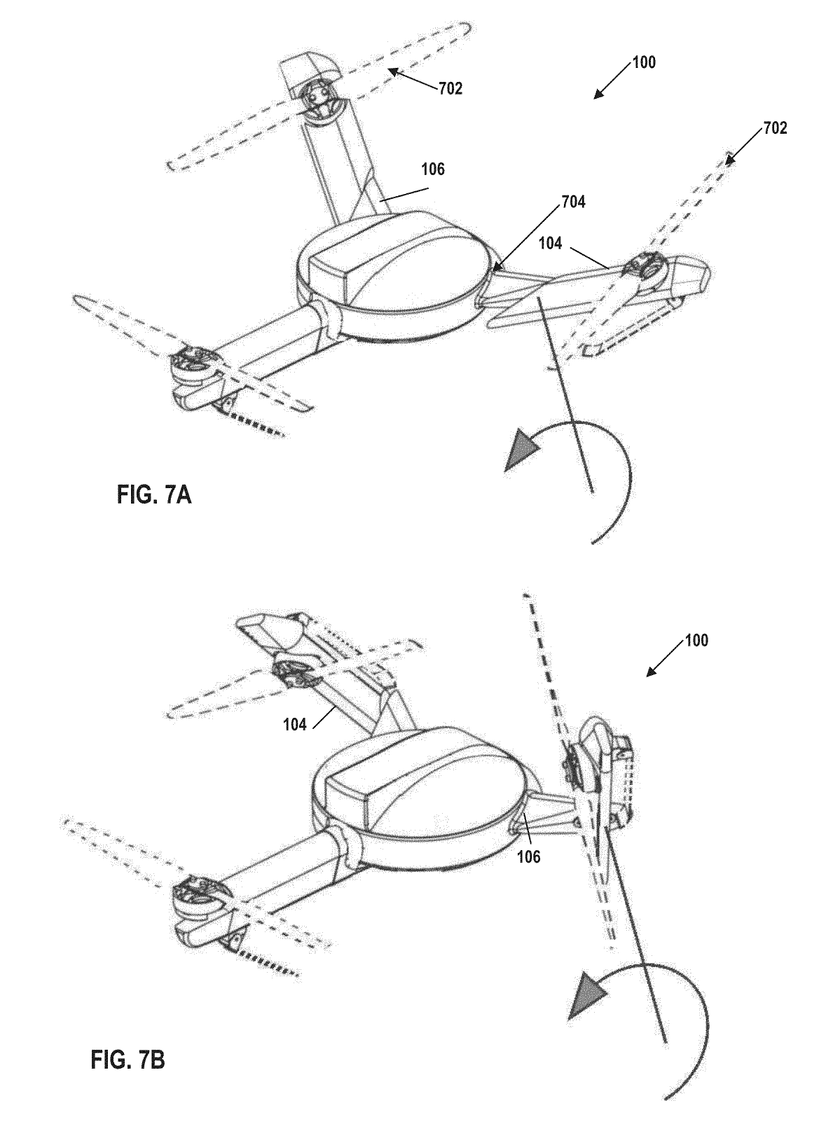

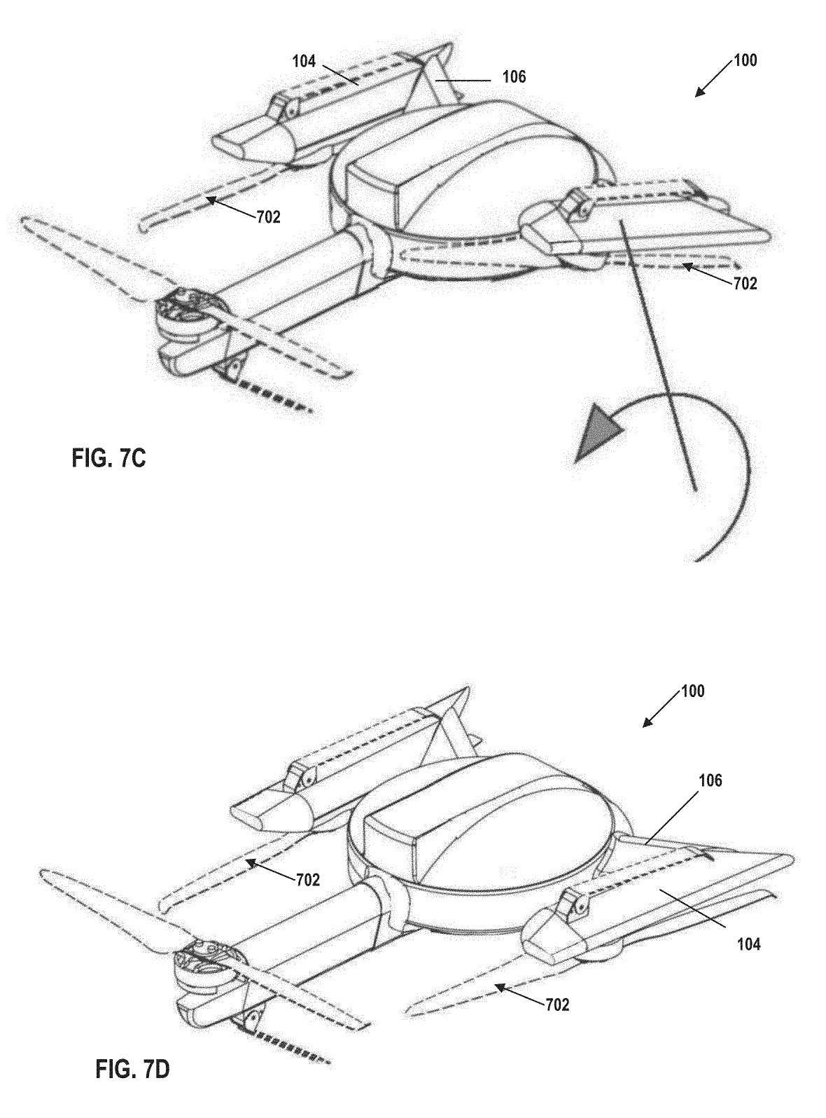

FIGS. 7A-7D depict a further exemplary implementation of UAV 100. Specifically, FIGS. 7A-7D depict various stages of the process of the collapse/folding and rotation of rays 102. As shown in FIG. 7A-7D, in certain implementations rays 102 can be attached/mounted to base 105 via a hinge, joint, etc. 704 that enables the rays 102 to rotate in relation to the base, as shown (such that, for example, the ray can be rotated 180 degrees, resulting in the propeller(s) 702 going from facing up to facing downwards in relation to the UAV). In doing so, the UAV 100 can be folded into yet a further smaller size (e.g., when transported).

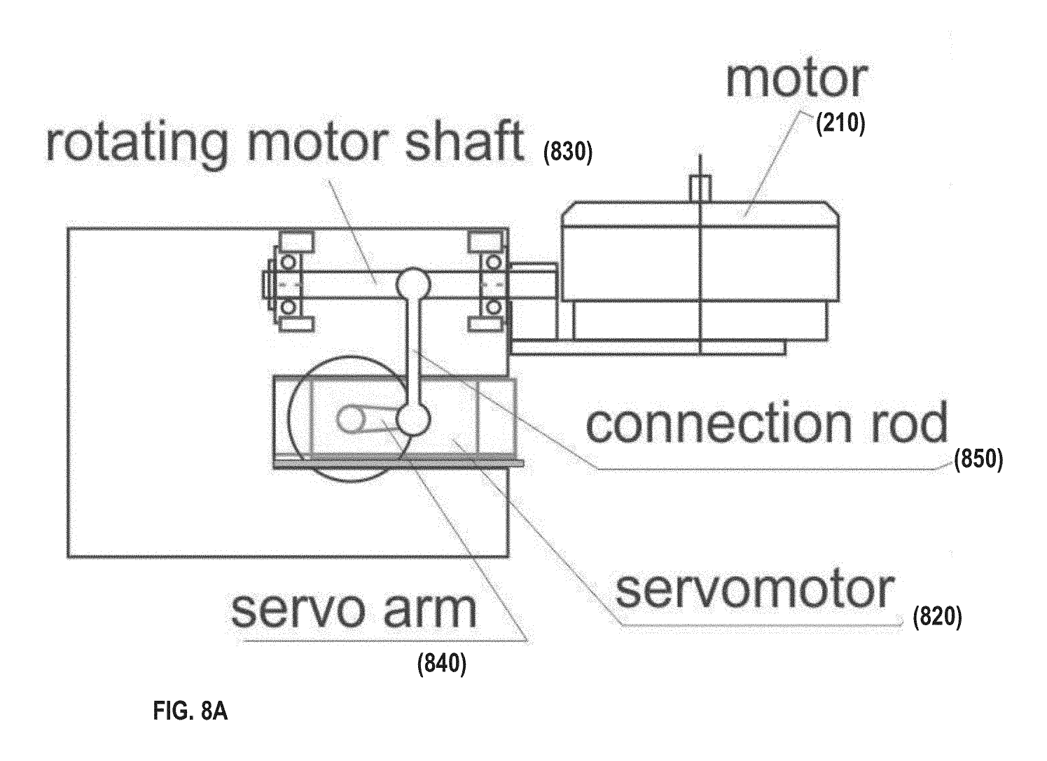

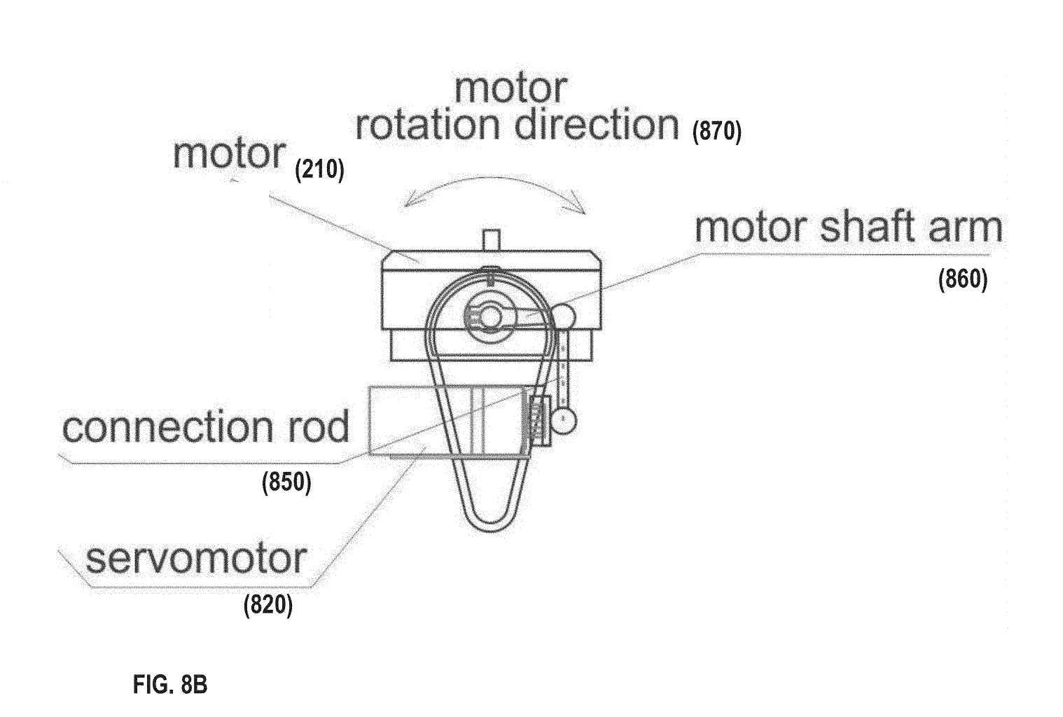

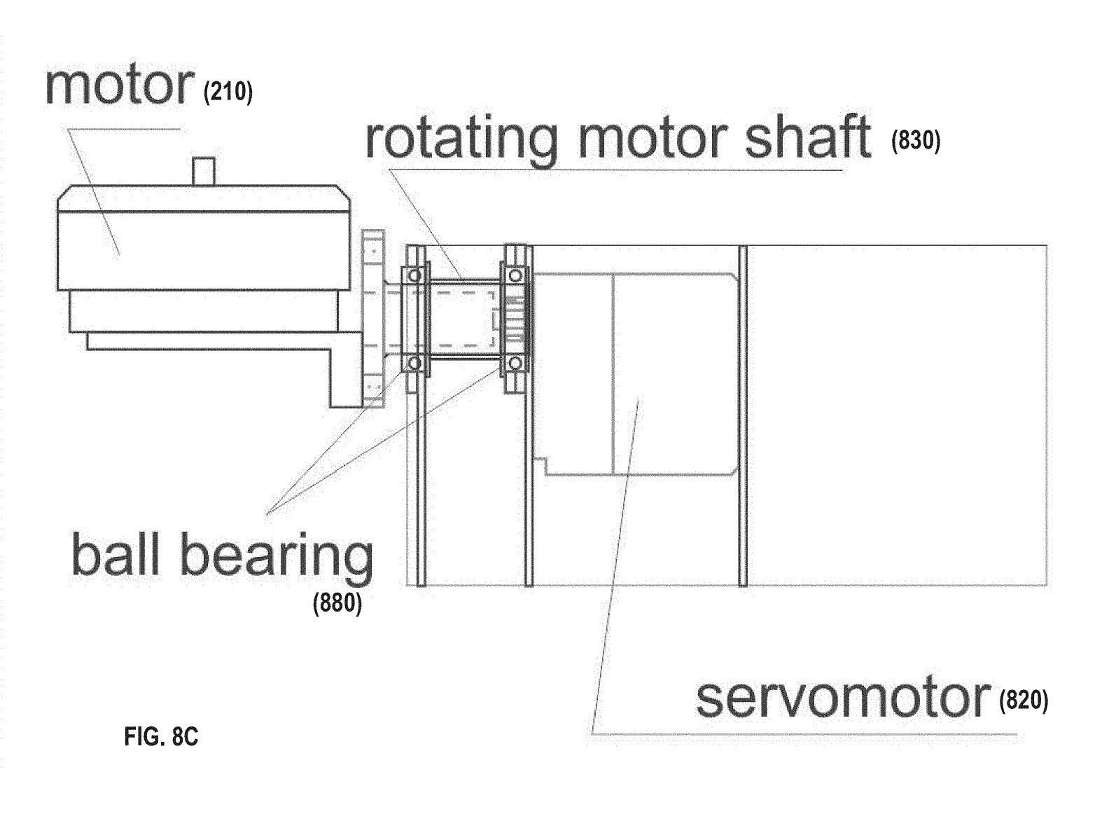

FIG. 8A-8C depict further aspects of UAV 100. As shown, in certain implementations, the rear ray 103 of the described UAV 100 can be configured/constructed to enable improved direction control by enabling compensation of reactive torque produced by the rear propeller.

FIGS. 8A and 8B illustrate one example implementation of motor 210 as mounted on a rear ray of a UAV (it should be noted that FIG. 8A depicts various components according to one perspective and FIG. 8B depicts such components from another perspective). It can be appreciated that, as is shown in FIGS. 8A-8B, in certain UAVs, a motor 210, e.g., as mounted within a rear ray of the UAV, can be rotated (e.g., in accordance with motor rotation direction 870) based on a construction in which effort/energy from the servomotor 820 is transmitted to the rotatable motor shaft 830 by server arm 840 and connection rod 850. As a result of such a construction (such as is depicted in FIGS. 8A-8B) which includes kinematic connections, effort/energy generated by the servomotor 820 can be lost due to friction, e.g., the rubbing of the hinge rod assemblies, as well as backlash.

FIG. 8C illustrates another example implementation of motor 210 as mounted on rear ray 103 of UAV 100. As shown in FIG. 8C, in certain implementations the described UAV 100 can incorporate a rear ray 103 through which direct control of the rotary axis can be enabled. Accordingly, as shown in FIG. 8C, the force/energy can be transmitted/transferred directly from the shaft of the servomotor 820 to the rotating motor shaft, as shown in FIG. 8C (in contrast to the technique depicted in FIGS. 8A and 8B).

It should also be understood that the rotary motor shaft 830 can be mounted in two ball bearings 880, as shown in FIG. 8C. In doing so, the amount of friction/energy loss can be minimized. Additionally, the backlash in the described/depicted technologies remains only where the structure is incorporated with the servomotor.

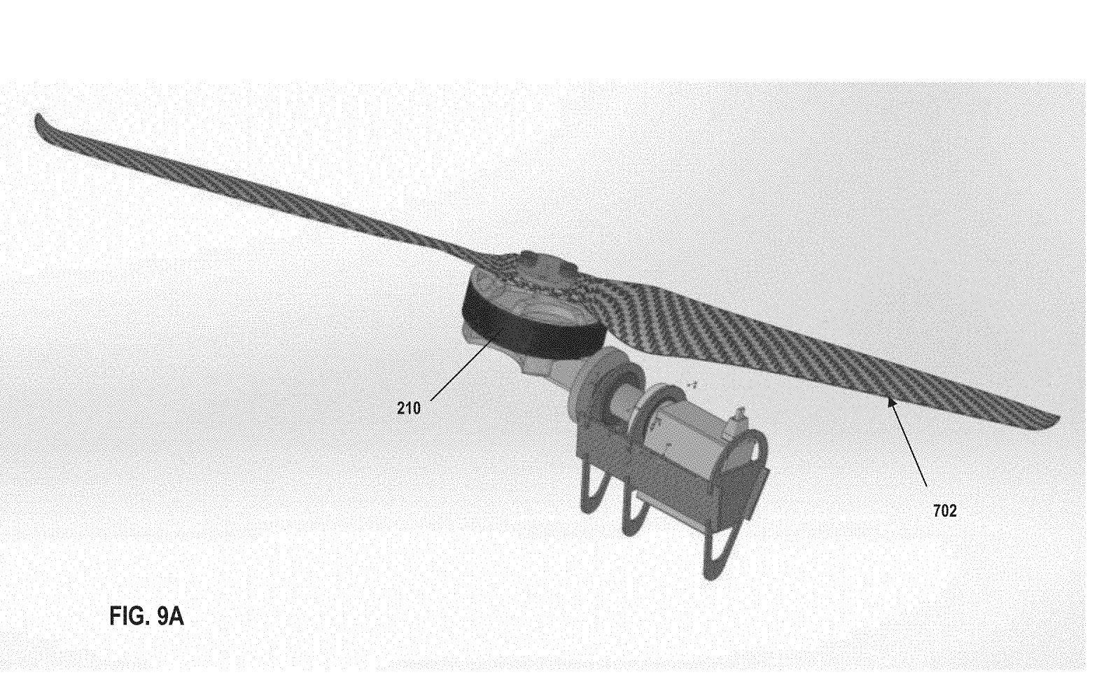

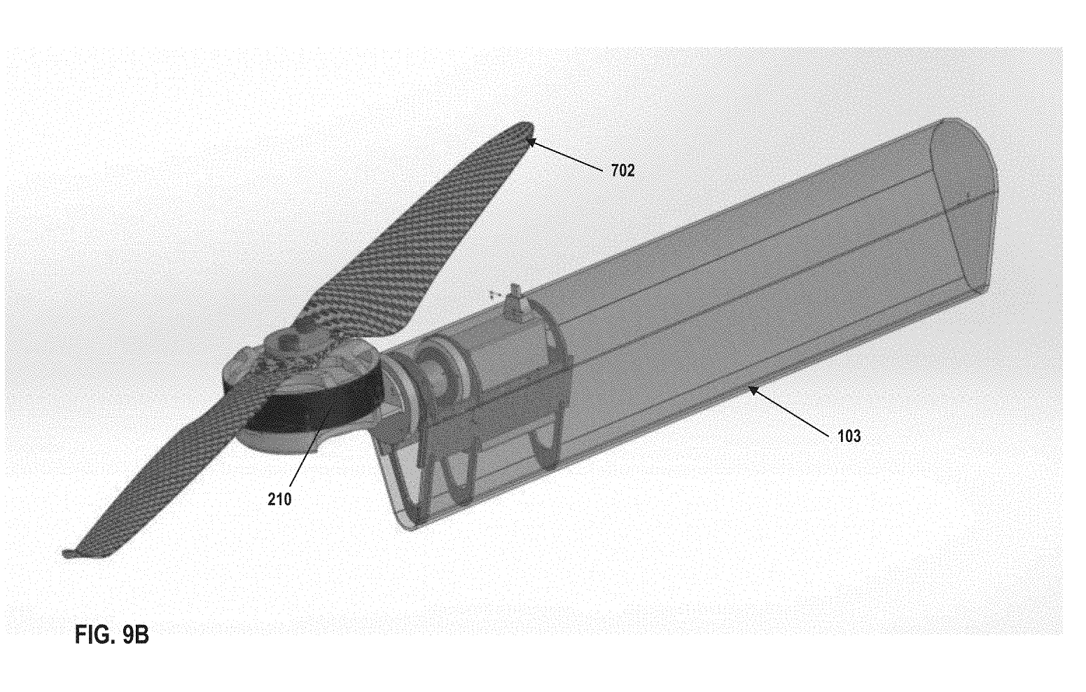

FIG. 9A further depicts the referenced motor 210 and related elements (including propeller 702, etc.) while FIG. 9B depicts the motor 210, etc., as incorporated within rear ray 103 of UAV 100.

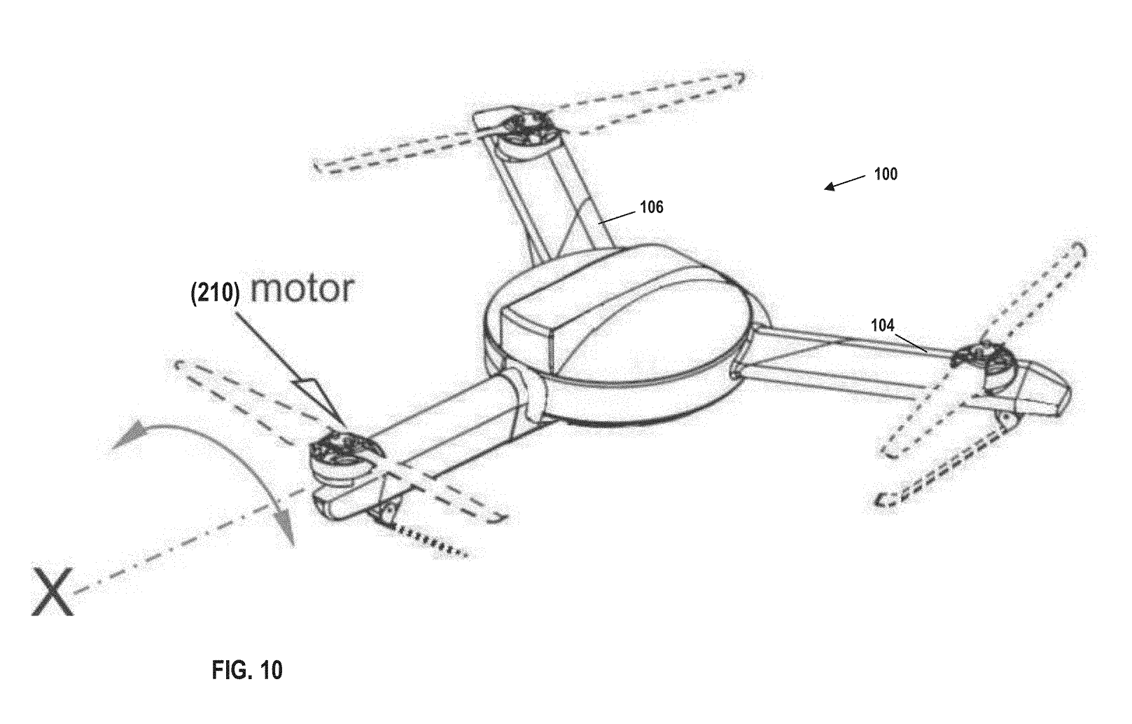

FIG. 10 further depicts UAV 100 and illustrates how motor 210 (including propeller 702, etc.) can be mounted or affixed to rear ray 103 via a rotating element such that the motor 210 can pivot along the ‘X’ axis, as shown. Doing so can, for example, improve various navigational aspects of the UAV 100, as described above.

It should also be understood that the components referenced herein can be combined together or separated into further components, according to a particular implementation. Additionally, in some implementations, various components of a particular element may be distributed across multiple elements.

It should also be noted that while the technologies described herein are illustrated primarily with respect to collapsible UAVs, the described technologies can also be implemented in any number of additional or alternative settings or contexts and towards any number of additional objectives. It should be understood that further technical advantages, solutions, and/or improvements (beyond those described and/or referenced herein) can be enabled as a result of such implementations.

As used herein, the term “or” can be construed in either an inclusive or exclusive sense. Moreover, plural instances can be provided for resources, operations, or structures described herein as a single instance. It is to be understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. A vehicle comprising:
a base;
a plurality of front-facing arms extending from the base, each front facing arm comprising an inner segment affixed to the base and an outer segment; and
a rear-facing arm affixed to the base.

2. The vehicle of claim 1, wherein the inner segment and the outer segment are joined by at least one of a hinge or a joint.

3. The vehicle of claim 1, wherein at least one of the plurality of front-facing arms can be positioned in at least one of (a) a locked position or (b) an unlocked position.

4. The vehicle of claim 1, wherein the outer segment of at least one of the plurality of front-facing arms comprises a lock that enters into a slot present within the inner segment of the at least one of the plurality of front-facing arms.

5. The vehicle of claim 1, wherein the outer segment of at least one of the plurality of front-facing arms comprises a motor.

6. The vehicle of claim 1, wherein the outer segment of at least one of the plurality of front-facing arms comprises a propeller.

7. The vehicle of claim 1, wherein, when folded, the outer segment of at least one of the front facing arms is parallel to a rear arm of the vehicle.

8. The vehicle of claim 1, wherein, when folded and rotated, the outer segment of at least one of the front facing arms is parallel to a rear arm of the vehicle.

9. The vehicle of claim 1, wherein the inner segment is affixed to the base via a hinge or joint.

10. The vehicle of claim 9, wherein the hinge or joint, when rotated, enables the front facing arm to rotate in relation to the base.

11. The vehicle of claim 9, wherein the hinge or joint, when rotated, enables the front facing arm to rotate up to 180 degrees in relation to the base.

12. The vehicle of claim 1, wherein the rear-facing arm comprises a motor and a servomotor.

13. The vehicle of claim 12, wherein the motor is attached to a motor shaft that is attached to the servomotor.

14. The vehicle of claim 13, wherein force originating from the servomotor is transferred directly to the motor shaft.

15. The vehicle of claim 13, wherein the motor shaft is mounted in a plurality of ball bearings.

16. A collapsible unmanned aerial vehicle (UAV) comprising:
one or more arms mounted to a base;
wherein at least one of the one or more arms comprises a first segment that is proximate to the base and a second segment that is distant from the base;
wherein a first hinge connects the first segment and the second segment; and
wherein one or more dimensions of the UAV are reduced when the at least one of the one or more arms is folded along the first hinge.

17. The UAV of claim 16, wherein a second hinge attaches the first segment to the base.

18. The UAV of claim 16, wherein the second hinge, when rotated, enables the at least one of the one or more arms to rotate in relation to the base.

19. The UAV of claim 16, wherein the hinge, when rotated, enables the at least one of the one or more arms to rotate up to 180 degrees in relation to the base.

20. An apparatus comprising:
a base, and
a plurality arms extending from the base;
wherein at least one of the arms comprises a motor, a propeller, an inner segment affixed to the base and an outer segment; and
wherein the inner segment is affixed to the base via a hinge that, when rotated, enables the at least one of the arms to rotate up to 180 degrees in relation to the base.
